(19) United States
(12) Patent Application Publication
(10) Pub. No.: US 2004/0199407 A1
(43) Pub. Date: Oct. 7, 2004

(54) System for processing data related to a partial reimbursement claim

(76) Inventor: Thomas V. Prendergast, Jamison, PA (US)

Correspondence Address: Alexander J. Burke, Intellectual Property Department, 5th Floor, 170 Wood Avenue South, Iselin, NJ, 08830, US

(21) Appl. No.: 10/780,523

(22) Filed: Feb. 17, 2004

Related U.S. Application Data
(60) Provisional application No. 60/457,127, filed on Mar. 24, 2003.
(60) Provisional application No. 60/457,073, filed on Mar. 24, 2003.

(51) Int. Cl. G06F 17/60

(52) U.S. Cl. 705/2

(57) ABSTRACT

A system automatically verifies partial claim data. A first map associates each data item in the partial claim data with a set of verification rules. An interface processor receives a set of partial claim data and a claims processor applies the associated verification rules to the received set of partial claim data.

The present Utility patent application is based on Provisional patent application No. 60/457,127, filed on Mar. 24, 2003.

### FIELD OF THE INVENTION

The present invention relates generally to the field of claim preparation data processing, and more particularly to systems that facilitate the management and validation of insurance or reimbursement claim documentation.

### BACKGROUND OF THE INVENTION

Hospitals, physicians' offices and dental offices rely heavily on medical insurance reimbursement payments as their major cash flow component. While much insurance claim data exists in electronic form, a significant proportion of all claims for reimbursement submitted by healthcare providers do not conform to the requirements of the payer and are therefore are initially rejected as invalid.

Existing insurance claim filing systems that have attempted to address the problem of invalid claims typically apply a set of validation rules at the end of the claim creation process. When these systems detect an invalid claim, the claim is returned to the initiator to request the required but missing information. The required information is almost always with individuals who are not immediately present and available, however. Arrangements are made to contact those individuals to get the missing information. Such a procedure delays the timely submission of complete and valid claims and consequently delays reimbursement. Furthermore, the amount of additional clerical work inherent in such a system increases healthcare provider costs.

Other insurance claims management systems use a computerized system including a portable device and its associated software. Such a device is intended for use by physicians and hospital staff at the point of patient care. While the device prompts a healthcare practitioner to capture and process information relevant to specific payer rules and procedures during a patient encounter, the creation and validation of an actual reimbursement claim is not accomplished. Further, the device is able to perform its data compliance tasks only by combining the point of patient care with the point of data capture, a situation not always achievable in a real world healthcare environment.

Yet other systems automatically and repeatedly interact with patient related information to ensure that it is correct according to payer rules prior to using that information for validating a claim. If an error is found the system performs a correcting action and subsequently uses the corrected information to validate an insurance claim. The tasks related to billing are performed after a patient visit and the start of the inspection of a claim occurs following patent check out. The medical care provider completes a claim entry form which ultimately becomes the claim itself after inspection and validation by the disclosed system.

Rules processors exist which are executed on a full set of claim data after the patient has become inactive. They have been implemented in a variety of coding mechanisms and have the problems described above if any data is missing or incorrect. A system which addresses and solves the problems described above is desirable.

### SUMMARY OF THE INVENTION

The inventor has realized that a need exists for a system usable by substantially all payers, healthcare providers and claims intermediaries that will allow individual portions of a partial claim to be validated as the information relevant to that section of the claim is available rather than after an entire claim is completed.

In accordance with principles of the present invention, a system automatically verifies partial claim data. A first map associates each data item in the partial claim data with a set of verification rules. An interface processor receives a set of partial claim data and a claims processor applies the associated verification rules to the received set of partial claim data.

A system according to the principles of the present invention validates the accuracy and completeness of data contained in partially completed claims for insurance or other reimbursement. The system enables a new or existing processing engine to apply rules that permit the validation of only a portion of a reimbursement claim based on the information available at that time. This capability allows healthcare providers to validate information as it is collected and to react to invalid or incomplete information at the point of data capture. At any point in the data collection path, such as when a patient is admitted, the information that is collected as part of that workflow step can be validated as it pertains to the production of a health insurance claim.

### BRIEF DESCRIPTION OF THE DRAWINGS

FIG. 1 is a schematic block diagram of a first embodiment of the claim data processing system of the present invention;

FIG. 2 is a schematic block diagram of a second embodiment of the claim data processing system of the present invention;

FIG. 3 is a schematic block diagram of a third embodiment of the claim data processing system of the present invention; and

FIG. 4 is an example of a graphical user interface used in conjunction with the system illustrated in FIGS. 1-3.

### DETAILED DESCRIPTION OF THE INVENTION

The reimbursement claims processing system of the present invention is a software application designed to meet the needs of different types or groups of end users as well as the payers in an insurance claims processing setting. Examples of different groups of end users include healthcare providers and claims administrators. Each type or group of end users supplies some, but not necessarily all, of the information required in a claim for reimbursement from a payer. A complete claim is defined as a claim that, when submitted to a payer, will generate a payment to the healthcare provider. Such a claim will include all data required by the payer in accurate form.

As a patient proceeds through the interaction with the healthcare organization, claim information is gathered. At any time, some claim information may be available and some may be as yet unavailable. Some of the available claim information may have values: patient name, address, etc., and some may intentionally be blank, for example a nickname. A partial claim includes only some of the data required by the payer.

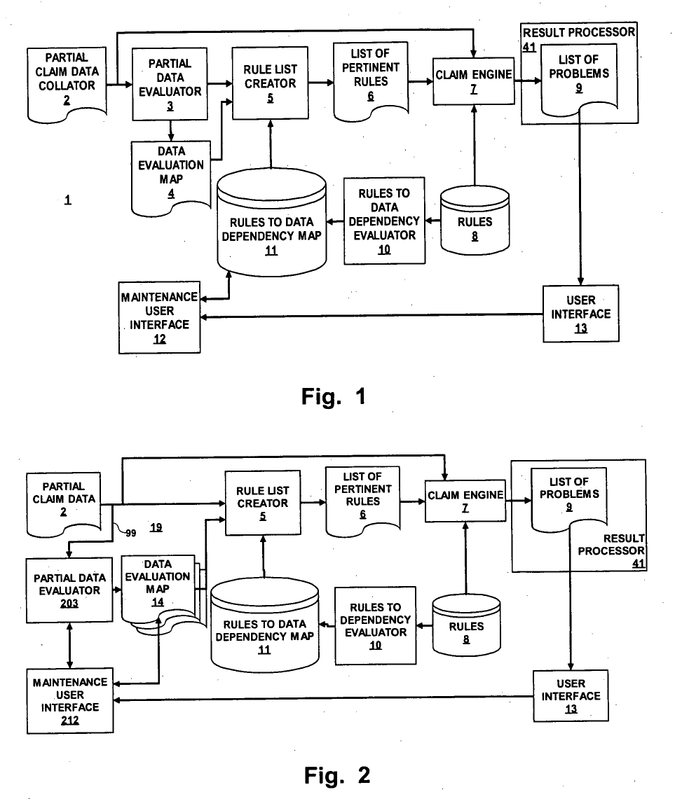

FIG. 1 is a schematic block diagram of a first embodiment 1 of the claim data processing system of the present invention. In FIG. 1, the claims processing system 1 includes a partial claim data collator 2 that solicits and receives information from an end user relevant to generating a reimbursement claim and/or contains pre-existing information relevant to topics such as identifying the patient, his insurance policy, services performed for the patient by the healthcare provider and the costs associated with those services. The partial claim data processed by collator 2 may be entered manually by the end user or produced by a compatible external data generation system such as the portable devices described above.

In the system illustrated in FIG. 1, the partial claim data collator 2 is implemented to gather claim data information at different stages in the patient interaction with the healthcare provider. For example, at the beginning of the initial visit, personal information is gathered from the patient, e.g. name, address, phone number, insurance company, etc. Subsequent stages will generate further data. Furthering the example, the consultation with the doctor will generate clinical information, diagnosis and treatment data.

The partial claim data 2 gathered at any stage of the patient interaction is forwarded to a partial data evaluator 3. The partial data evaluator 3 analyzes the partial claim data and produces a data evaluation map 4. The evaluation map 4 contains information specifying which information in the partial claim can be validated and also which can be used to validate other information. Continuing the above example, at the beginning of the initial visit the evaluation map 4 contains data specifying that name, address, phone number, insurance company etc. data has been supplied, and that no clinical diagnosis or treatment data has been supplied. In general, the evaluation map 4 contains information about what data fields are eligible for further processing at the time the map is created.

Data representing all possible payer specified rules that may be applied to claims when verifying their completeness and accuracy reside in a rules database 8. A rules-to-data-dependency evaluator 10 is executed at the beginning of each partial data processing cycle. The evaluator 10 scans the rules database 8 in order to determine which rule(s) are applicable to each claim data field and generates a rules-to-data-dependency map 11 containing data representing this information. More specifically, one or more rules may be applicable to determine the accuracy of a data field and one or more other rules when applied may use the content of this data field in determining the accuracy of a different data field. That is, the rules-to-data-dependency-map 11 contains data that, for each field of information in a claim, identifies the rule or rules in the rules database 8 which are related to that field. The content of the map 11 is available for manual review and maintenance via a user interface 12, as described in more detail below.

A rules list creator 5 receives data from both the data evaluation map 4 and the rules-to-data-dependency map 11. Using the information received from both sources, the rules list creator 5 produces a list 6 of pertinent rules which should now be invoked with respect to the existing data 2. More specifically, the rule list creator 5 receives the list of data fields containing data from the data evaluation map 4. For each such data field, the rule list creator 5 locates the entry in the rules-to-data-dependency map 11 corresponding to that data field, and retrieves the rules applicable to that data field. Data representing the retrieved rules is stored in the list of pertinent rules 6.

A claims preprocessor or claim engine 7 retrieves the data representing the list of pertinent rules from list 6, retrieves data directing application of the rules themselves from the rules database 8, and then applies the selected rules to the available partial claim data 2. The claims engine 7 identifies and inspects all available data fields, both blank and valued, appearing as part of the partial claim data 2 in a manner directed by each pertinent rule. More specifically, the claims engine 7 checks for predetermined data conditions in the partial claim data 2, as described by corresponding data from the rules database 8. These data conditions may include conditions on a single data field or conditions involving multiple data fields.

A list 9 of problems identified by application of the pertinent rules is generated by the claims engine 7. The problems may include (a) an invalid data item, (b) an incomplete data item, (c) a missing data item that is necessary for claim submission and determinable from a partial claim data, and/or (d) a data item field which contains an entry when it should be blank. For example, one or more rules may be applied to a zip code data field. If the zip code data field is blank but the city and state fields are valued, then a problem with the patient address data is indicated and data representing this problem is added to the problem list 9. More generally, the claims engine 7 determines whether the available claim data from the partial claim data collator 2 is accurate and complete. If so, then the partial claim is in a condition for further processing and eventual generation of a payment upon completion of the partial claim. If not, data representing any identified problems is added to the problem list 9.

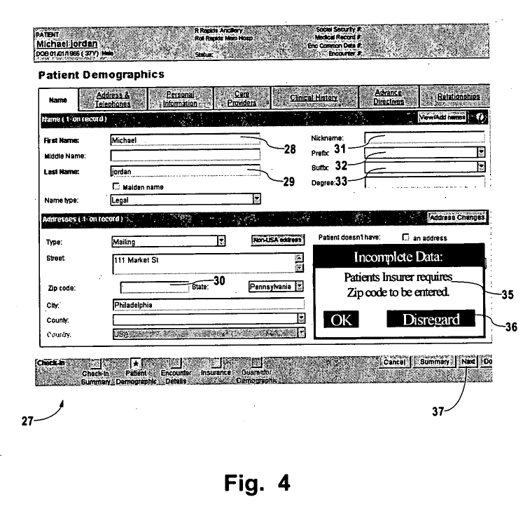

After the selected rules are applied, a list 9 of data fields that are invalid or incomplete is created by a results processor 41 and made available to the user via a user interface 13. The user interface 13 may be implemented by circuitry for displaying an image on a display device such as a computer monitor (not shown) and for receiving input from a user via a keyboard or mouse (also not shown). FIG. 4 is an image of an admissions screen 27 that may displayed via the user interface 13. Numerous data fields, for example, 28, 29, 30, 31, 32 and 33, appear on the screen 27. Some data fields, e.g. 28 and 29, are populated, and other data fields, e.g. 30, 31, 32 and 33, are unpopulated. Some of the unpopulated fields, e.g. 31, 32 and 33, are not required. However, in this example the unpopulated zip code field 30, is a field that is required to have a value. Data representing all the detected problem data fields, such as the required but missing zip code data 30, is stored in the list of problems 9 (FIG. 1).

The result processor 41 extracts data from the list of problems 9 and sends that data to the user interface 13. In response, the user interface displays an alert message related to each problem data field, substantially in real time. FIG. 4 illustrates such an alert message in the form of an error message 35. The error message 35 indicates that the zip code field 30 should be completed in order for the partial claim data to be validated. The user, in this case an admissions clerk, may ask the patient who supplied the rest of the data in the partial claim for the zip code during the admission process. Thus, the problem is able to be corrected while the patient is still present at the admissions desk.

The user may also recommend updates to the rules-to-data-dependency-map 11 based on a review of the errors in the problem list 9 via the user interface 13. For example, upon reviewing a displayed error message, such as 35, the user may provide an indication that the error is not applicable to the current circumstance. In FIG. 4, for example, the user has the option of selecting a Disregard button 36, to indicate a recommendation from an end user that the prompt for a zip code should in this case be ignored. The user interface 13 forwards this indication to the maintenance user interface 12. Such user recommendations thereby become accessible via the maintenance user interface 12, which permits a maintenance user to review the user recommendations and provides a mechanism for updating the rules-to-data-dependency-map 11 as appropriate.

FIG. 2 is a schematic block diagram of a second embodiment 19 of the claim data processing system of the present invention. The partial claim data 2 is produced by an external method, as described above. However, in the embodiment illustrated in FIG. 2, instead of dynamically creating the previously discussed data evaluation map 4 from the received partial claim data 2, a plurality of previously created, application specific, data evaluation maps 14 are used for each respective situation. That is, a previously created map 14 for patient admission is used for the validation of partial claim data collected during the patient admission process.

The partial data evaluator 203 and maintenance user interface 212 may be used to create and/or maintain each of the dedicated data evaluation maps 14. For example, the data evaluator 203 may have produced, as a result of previously operating in the manner of the first embodiment described above, as illustrated by signal line 99 in FIG. 2), respective maps 14 suitable for dedicated use with respect to specific situations. Alternatively, the maintenance user interface 12 can be used to create a new data evaluation map 14 or modify an existing data evaluation map 14 for new situations.

When partial claim data 2 is received, the specific situation is determined, e.g. admissions process. The appropriate one of the data evaluation maps 14 is selected for use in evaluating the received partial claim data 2. Once the dedicated map 14 is selected, the remainder of the system illustrated in FIG. 2 operates in the same manner described above with respect to FIG. 1. That is, the rules list creator 5 receives both the dedicated data evaluation map 14 and the rules-to-data-dependency map 11 as inputs. The rules list creator 5 produces a list 6 of rules to be applied. The list 6 is forwarded to the claims engine 7 which retrieves the specified rules from the rules database 8 and then applies the rules to the partial claim data 2. A list 9 of problems with the data is produced for review at user interface 13. The user may correct the data as directed by the user interface 13 or may comment on the accuracy of the error list 9, those comments being accessible via the maintenance user interface 12 for use in updating the dedicated data evaluation map 14.

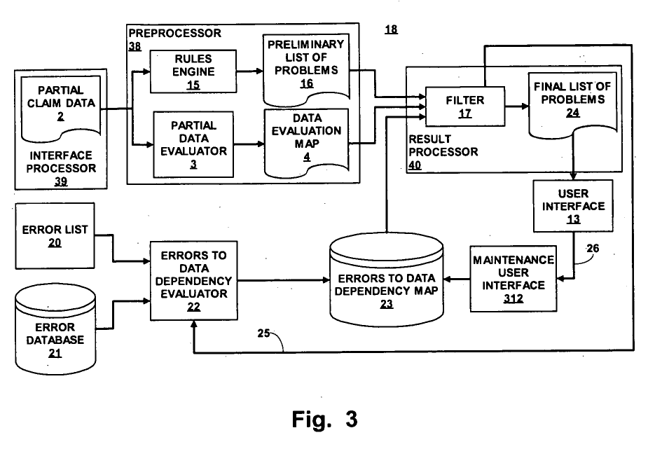

FIG. 3 is a schematic block diagram of a third embodiment 18 of a partial claim data processing system according to the present invention. In FIG. 3, an interface processor 39 is conditioned to receive the partial claim data 2 that is produced by some external system. The interface processor 39 transmits that data to a preprocessor 38 that includes a partial data evaluator 3. The partial data evaluator 3 generates a data evaluation map 4 containing information indicating which data fields may either be validated and/or used in the validation of other data fields, as described above with respect to FIG. 1. In other words, the data evaluation map 4 identifies those data fields eligible for further processing. The generated data evaluation map 4 may also be retained, refined and used for subsequent partial claim information validation, as described above with respect to FIG. 2.

Concurrently, the partial claim data 2 is forwarded to the claim or rules engine 15. Unlike the rules processor 7 illustrated in FIGS. 1 and 2 and described above where only selected rules are applied to evaluate the partial claim data 2, the rules engine 15 illustrated in FIG. 3 applies all validity rules to the partial data 2 as if the partial claim data 2 were a complete set of data in which all necessary fields were properly populated. Because the partial claim data 2 is incomplete, many problems are identified by the rules engine 15. Some of these problems are potential problems which relate to data which is not yet present in the partial claim. Other problems are real and relate to inaccurate or missing data in the data which is present in the partial claim, such as a missing zip code as described above. The list of problems 16, thus, is a preliminary list.

At the beginning of each data processing cycle performed by system 18, a list of errors stored in a file 20 and/or in an error database 21 produced at the completion of previous data processing cycles is retrieved and processed by an error-to-data-dependency evaluator 22. The evaluator 22 processes the pre-existing error data and creates an error-to-data-dependency map 23 that indicates the relationship between errors and particular data fields. That is, the errors-to-data-dependency map 23 provides a correspondence between each error previously found by the rules engine 15 and the data fields in the claim data which were involved in producing the error.

The list 16 of current real or potential problems, along with the data evaluation map 4 and the error-to-data-dependency map 23 is forwarded to a result processor 40. The result processor 40 includes a filter 17 that passes the current real problems and filters out the potential problems. The filter 17 identifies or correlates the errors present in the current partial data 2 with the larger database 21 of known or pre-existing data problems. Each error in the preliminary list of problems 16 is used to access the entry in the errors-to-data-dependency map 23 corresponding to that error. The map 23 produces the data fields which relate to that error. Those data fields are then compared to the data fields in the data evaluation map 4 to determine if all of them are available for further processing. If so, then this error is based on available data fields and is a valid problem. This problem is then sent through to a final list of problems 24. If, on the other hand, any of the data fields related to the error are not available for further processing, then this problem is a potential problem, but not yet one that may be corrected. This problem is not sent through to the final list of problems 24.

The filter 17 thereby produces a final list 24 of problems in the current partial claim data 2 based on both all the rules and the database of previously known data problems. If problems are present in the final list 24 that do not appear in the errors-to-data-dependency map 23, the filter 17 invokes the error-to-data-dependency-evaluator 22 and sends data representing the new error via path 25 in order to dynamically update the error-to-data-dependency relationship for the previously unclassified errors.

When the final list of errors 24 is produced, each error causes an appropriate message to immediately appear on the user interface 13, as described above and illustrated in FIG. 4, and the user has an opportunity to substantially immediately correct the data while the source of the data is still available. The user viewing the error message can also recommend updates to the errors-to-data-dependency map 23 via feedback 26 sent to the Maintenance User Interface 312.

In operation, a patient goes, for example, to the admissions department to check into a hospital. Referring to FIG. 4, the admissions clerk collects demographic data, but does not collect the Zip code as required in field 30. As the clerk selects the Next button 37 to save the data appearing on screen 27 and proceed to the next screen, the external data gathering system creates partial claim data 2 and that data is forwarded to the present system 1, as illustrated in either FIG. 1, FIG. 2, or FIG. 3. The system 1 then performs as described above and responds with the message 35 that for this particular insurer, the zip code field 30 should be completed. The clerk then asks the patient for his zip code and enters it into the external data gathering system. Any other error messages are handled the same way until the system indicates that no further problems exist. The next screen may then be accessed.

At each subsequent stage in the patient's interaction with this healthcare provider, similar data entry (by data entry clerk, doctor, etc.) and partial data validation is performed while the source of the data (e.g. the patient) is still present. After the patient is discharged, a full claim is submitted for a validity check, and, if necessary, is corrected, until it is in a condition to be approved by the payer. The claim is sent immediately to the payer for reimbursement. No delay is encountered, nor is subsequent human intervention required to contact the patient to get any missing, necessary information such as a zip code.

One skilled in the art will recognize that in one embodiment, available data is determined and a subset of rules dependent only on the available data is applied to the partial claim data. In another embodiment, all rules are applied to the partial claim data but only a subset of resulting errors, dependent only on the available data, are passed to the user. In either case, partial claim data is validated to the extent possible and error messages returned to the user in real time so that any inaccurate or missing data may be corrected while the source of the data is still present. The present invention may be embodied in other specific forms which would permit the real time validation of partial claim data.

The present invention has been described as related to partial claim validation in a healthcare environment. However, the present invention may be used in any environment where data collection is performed in stages and requires validation.

What is claimed is:

1. A system for processing partial claim data related to provision of healthcare to a patient, comprising:
an interface processor for receiving data representing a partial claim for reimbursement for services provided to a patient;
a pre-processor for processing said data representing said partial claim to identify deficiencies in said partial claim, said processing including:
applying rules to said data representing said partial claim to identify errors in said partial claim, and
determining a subset of said errors attributable to at least one of, (a) an invalid data item and (b) an incomplete data item, in said partial claim representative data; and
a result processor, for initiating generation of an alert message identifying said subset of said errors to a user.

2. A system according to claim 1, wherein said pre-processor determines said subset of said errors by at least one of, (a) determining a data item necessary for claim submission and determinable from said partial claim representative data is missing and (b) a data item field contains an entry when it should be blank.

3. A system according to claim 1, wherein said pre-processor determines said subset of said errors using predetermined data conditions and by determining data conditions that are not satisfied by at least one of, (a) an individual data and (b) multiple data items, in said partial claim.

4. A system according to claim 1, wherein said rules are rules used to process data representing completed claims.

5. A system for processing partial claim data related to provision of healthcare to a patient, comprising:
a claim data collator for receiving and collating data related to a partial claim for a particular patient, said partial claim data being received from a data collection system;
a source of rules for use in processing collated claim data of a partial claim;
a pre-processor for submitting said collated claim data of said partial claim for processing using said rules to identify deficiencies in said collated claim data of said partial claim; and
a result processor, for initiating generation of an alert message identifying said deficiencies to a user of said data collection system and enabling said user to potentially correct said deficiencies.

6. A system according to claim 5, wherein said pre-processor determines whether said collated claim data of said partial claim is in condition for processing to initiate generation of a payment in response to completion of said partial claim.

7. A system according to claim 5, wherein said system automatically processes said partial claim data and initiates generation of said alert message identifying said deficiencies to said user during user collection of information from a patient using said data collection system enabling a user to correct said deficiencies before a collection session terminates.

8. A system according to claim 5, wherein said system automatically processes said partial claim data and initiates generation of said alert message substantially in real-time.

9. A system according to claim 5, wherein said pre-processor identifies at least one of, (a) blank data items and (b) valued data items, present in said partial claim.

10. A system according to claim 5, wherein said pre-processor determines a subset of said rules in said rules source relevant to said partial claim and processes said collated claim data of said partial claim using said subset of rules to identify deficiencies in said collated claim data of said partial claim.

11. A system according to claim 10, wherein said pre-processor determines a subset of said rules in said rules source relevant to said partial claim based on at least one of, (a) identified valued data items present in said partial claim and (b) a map linking particular rules of said rules source with particular items of claim data.

12. A system according to claim 11, further comprising a maintenance user interface, the maintenance user interface permitting a user of the system to monitor and modify rules employed by the claim preprocessor.

13. A system according to claim 12, wherein the map is a dedicated database appropriate for use during specified interactions with a provider of claim data.

14. A system for verifying partial claim data, comprising:
a first map respectively associating partial claim data items with a set of verification rules;
an interface processor for receiving a set of partial claim data; and
a claims processor, responsive to the received set of partial claim data and the first map, for applying the associated verification rules to the received set of partial claim data.

15. A system according to claim 14, further comprising a second map for identifying data present in the set of partial claim data that is available for the application of any verification rule.

16. A system according to claim 15, wherein the second map identifies data present in the set of partial claim data that is available for validating other data items.

17. A system according to claim 16, further comprising a rules list creator, for creating a list of rules to be applied by the claims processor to the received set of partial claim data.

18. A method for enabling a provider of reimbursable services to automatically identify invalid data present in partial claim data sets needed to complete a claim for reimbursement submitted to a payer, comprising the steps of:
receiving partial claim data pertaining to provision of reimbursable services to an individual;
creating a map containing data that associates:
(a) respective data items present within the received partial claim data; and
(b) a set of one or more payer specified reimbursement rules; and
conditioning a claims processor to apply to the received partial claim data the associated payer specified reimbursement rules as specified by the map and to identify data not complying with the applied rules as invalid.

19. A method according to claim 18, further comprising the steps of:
creating a list of invalid data identified as a result of applying payer specified rules to the received partial claim data;
forwarding the list to a user designated by a provider of the reimbursable service; and
prompting the user to correct an error causing the partial claim data to be identified as invalid without significant delay.

20. A method according to claim 19, further comprising the step of automatically transmitting to the payer valid data needed to complete the claim when sets of partial data have been inspected and no data remains identified as invalid.
